(19) United States
(12) Patent Application Publication
(10) Pub. No.: US 2016/0350773 A1
(43) Pub. Date: Dec. 1, 2016

(54) METHODS AND APPARATUS TO CORRECT AGE MISATTRIBUTION

(71) Applicant: The Nielsen Company (US), LLC, New York, NY (US)

(72) Inventors: Jonathan Sullivan, Natick, MA (US); Diahanna Post, San Francisco, CA (US); David Wong, New York, NY (US); Jonathon Wells, Tampa, FL (US); Oana Dan, New York, NY (US)

(21) Appl. No.: 14/957,258

(22) Filed: Dec. 2, 2015

Related U.S. Application Data
(60) Provisional application No. 62/167,768, filed on May 28, 2015.

(51) Int. Cl. G06Q 30/02

(52) U.S. Cl. CPC G06Q 30/0204

(57) ABSTRACT

Methods, apparatus, and articles of manufacture are disclosed to correct age misattribution. Example disclosed methods include, for a plurality of candidate models, determining a first score for the candidate model based on audience member records stored in a first memory, determining a second score for the candidate model based on the audience member records stored in the first memory; and determining a third score based on a weighted average of the first score and the second score, the third score representative of the accuracy of the corrective model. The example methods include selecting one of the plurality of candidate models to be an age-correction model based on the third score. The example methods include correcting, based on the selected age-correction model, an age associated with the media impression stored in a second memory, the media impression indicative of a person being exposed to media presented by a media presentation device.

### RELATED APPLICATION

This patent claims benefit of U.S. Provisional Application Ser. No. 62/167,768, which was filed on May 28, 2015, and is hereby incorporated herein by reference in its entirety.

### FIELD OF THE DISCLOSURE

This disclosure relates generally to audience measurement, and, more particularly, to methods and apparatus to correct age misattribution.

### BACKGROUND

Audience measurement entities measure exposure of audiences to media such as television, music, movies, radio, Internet websites, streaming media, etc. The audience measurement entities generate ratings based on the measured exposure. Ratings are used by advertisers and/or marketers to purchase advertising space and/or design advertising campaigns. Additionally, media producers and/or distributors use the ratings to determine how to set prices for advertising space and/or to make programming decisions.

Techniques for monitoring user access to media have evolved significantly over the years. Some prior systems perform such monitoring primarily through server logs. In particular, entities serving media on the Internet can use such prior systems to log the number of requests received for their media at their server.

### BRIEF DESCRIPTION OF THE DRAWINGS

FIG. 1 illustrates an example system constructed in accordance with the teachings of this disclosure.

FIG. 2 illustrates an implementation of the example model validator of FIG. 1 to evaluate and select age correction models.

FIG. 3 is a flow diagram of example machine readable instructions that may be executed to implement the example model validator of FIGS. 1 and/or 2 to evaluate and select age correction models.

FIG. 4 is a flow diagram of example machine readable instructions that may be executed to implement the example model validator of FIGS. 1 and/or 2 to evaluate and select age correction models.

FIG. 5 is a flow diagram of example machine readable instructions that may be executed to implement the example broad scorer of FIG. 2 to calculate broad scores for the candidate models.

FIG. 6 is a flow diagram of example machine readable instructions that may be executed to implement the example targeted scorer of FIG. 2 to calculate targeted scores for the candidate models.

FIG. 7 is a block diagram of an example processor system is structured to execute any of the machine readable instructions represented by FIGS. 2, 3, 5, and/or 6 to implement the apparatus of FIGS. 1 and/or 2.

Wherever possible, the same reference numbers will be used throughout the drawing(s) and accompanying written description to refer to the same or like parts.

### DETAILED DESCRIPTION

Examples disclosed herein may be used to generate age correction models that correct age misattribution in impression records. To measure audiences, an audience measurement entity (AME) may use instructions (e.g., Java, java script, or any other computer language or script) embedded in media to collect information indicating when audience members are accessing media on a computing device (e.g., a computer, a laptop, a smartphone, a tablet, etc.). Media to be monitored is tagged with these instructions. When a device requests the media, both the media and the instructions are downloaded to the client. The instructions cause information about the media access to be sent from the device to a monitoring entity (e.g., the AME) and/or a database proprietor (e.g., Google, Facebook, Experian, Baidu, Tencent, etc.). Examples of tagging media and monitoring media through these instructions are disclosed in U.S. Pat. No. 6,108,637, issued Aug. 22, 2000, entitled “Content Display Monitor,” which is incorporated by reference in its entirety herein.

Additionally, the instructions cause one or more user and/or device identifiers (e.g., an international mobile equipment identity (IMEI), a mobile equipment identifier (MEID), a media access control (MAC) address, an app store identifier, an open source unique device identifier (OpenUDID), an open device identification number (ODIN), a login identifier, a username, an email address, user agent data, third-party service identifiers, web storage data, document object model (DOM) storage data, local shared objects also referred to as “Flash cookies”), browser cookies, an automobile vehicle identification number (VIN), etc.) located on the computing device to be sent to a partnered database proprietor to identify demographic information (e.g., age, gender, geographic location, race, income level, education level, religion, etc.) for the audience member of the computing device collected via a user registration process. For example, an audience member may be exposed to an advertisement entitled “When Pigs Fly” in a media streaming website on a tablet. In that instance, in response to instructions executing within the website, a user/device identifier stored on the tablet is sent to the AME and/or a partner database proprietor to associate the instance of media exposure (e.g., an impression) to corresponding demographic information of the audience member. The database proprietor can then send logged demographic impression data to the AME for use by the AME in generating, for example, media ratings and/or other audience measures.

In some examples, the partner database proprietor does not provide individualized demographic information (e.g., user-level demographics) in association with logged impressions. Instead, in some examples, the partnered database proprietor provides aggregate demographic impression data (sometimes referred to herein as “aggregate census data”). For example, the aggregate demographic impression data provided by the partner database proprietor may show that eighteen hundred males age 18-23 were exposed to the advertisement entitled “When Pigs Fly” in the last seven days via computing devices. However, the aggregate demographic information from the partner database proprietor does not identify individual persons (e.g., is not user-level data) associated with individual impressions. In this manner, the database proprietor protects the privacies of its subscribers/users by not revealing their identities and, thus, user-level media access activities, to the AME.

The AME uses this aggregated demographic information to calculate ratings and/or other audience measures for corresponding media. However, during the process of registering with the database proprietor, a subscriber may lie or may otherwise provide inaccurate demographic information. For example, during registration, the subscriber may provide an inaccurate age or location. These inaccuracies cause errors in the aggregate demographic information from the partner database proprietor, and can lead to errors in audience measurement. To combat these errors, the AME recruits panelist households that consent to monitoring of their exposure to media. During the recruitment process, the AME obtains detailed demographic information from the members of the panelist household. While the self-reported demographic information (e.g., age, etc.) reported to the database proprietor is generally considered to be potentially inaccurate, the demographic information collected from the panelist (e.g., via a survey, etc.) by the AME is considered highly accurate. As used herein, the term “true age” refers to age information collected from the panelist by the AME.

The AME also retrieves activity data from the partnered database proprietor. The database proprietor activity data includes self-reported demographic data (e.g., age, high school graduation year, profession, marital status, etc.), subscriber metadata (e.g., number of connections, median age of connections, etc.), and subscriber use data (e.g., frequency of login, frequency of posts, devices used to login, privacy settings, etc.). Examples of retrieving the activity data from the partnered database subscriber(s) are disclosed in U.S. patent application Ser. No. 14/864,300, filed Sep. 24, 2015, entitled “Methods and Apparatus to Assign Demographic Information to Panelists,” which is incorporated by reference in its entirety herein.

The AME develops age correction model(s) (e.g., decision tree models, regression tree models, etc.) to assign an age category (e.g., an age-based demographic bucket), an age category probability density function (PDF), and/or a discrete age to an audience member corresponding to a logged impression. The PDFs indicate probabilities that the audience member falls within certain ones of the respective age categories. The age correction models are generated using the database proprietor activity data of panelists and the detailed demographic information supplied by the panelist to the AME. To generate the age correction models, the database proprietor activity data is organized into attribute-value pairs. In the attribute-value pairs, the attribute is a category in the activity data (e.g., marital status, post frequency, reported age, etc.) and the value is the corresponding value (e.g., single, five times per week, twenty seven, etc.) of the attribute. For example, an attribute-value pair may be [percentage_connections_female, 50]. Examples for generating age correction models are disclosed in U.S. patent application Ser. No. 14/928,468, filed Oct. 30, 2015, entitled “Methods and Apparatus to Categorize Media Impressions by Age,” which is incorporated by reference in its entirety herein.

The AME maintains a database of audience member records that associate the database proprietor activity (e.g., collected from the database proprietor) and demographic information (e.g., collected by the AME). For example, the audience members records may associate a self-reported age (e.g., from a database proprietor) with a true age. The audience member records are divided into a training set and a validation set. Because the composition of the training sets and the validation sets affect performance of the age correction model, the audience member records are randomly divided into the training sets and the validation sets. For example, the audience member records may be randomly divided into a first training set and a first validation set, then the audience member records may be also randomly divided into a second training set and a second validation set, etc. Candidate models are developed from the training sets. Additionally, the candidate models are evaluated using the validation sets. For each of the candidate models, results of applying the validation sets are fused, resulting in an estimate of the actual performance of the candidate model.

Examples disclosed herein may be used to objectively validate the candidate models. To evaluate the candidate models, the AME generates a validation scores (Sᵥ) based on a broad score (S_{b}) and a targeted score (Sₜ). The AME uses the validation score (Sᵥ) to determine which one of the generated candidate models to use when determining the age to associate with a media impression. In some examples, the validation score (Sᵥ) is a weighted average of the broad score (S_{b}) and the targeted scores (Sₜ), where the weights are determined by business interests which may include the proportion of campaigns which are targeted campaigns.

In examples disclosed herein, the broad score (S_{b}) is used to capture the accuracy of the corrective model in cases which the composition of the target audience members is similar to the composition of the possible audience members as a whole. For example, the composition of the target audience members may include all of the demographic groups (e.g., age categories) that make up the population of the target region. The broad score (S_{b}) is based on a weighted prediction error of multiple validation sets.

In examples disclosed herein, the targeted score (Sₜ) is used to capture the accuracy of the model in cases of a targeted audience, where (i) the composition of the target audience members is narrow compared to the composition of the audience members as a whole, and/or (ii) the composition of the target audience members approaches a pure sample (e.g., audience members with the same demographic characteristics). For example, for an age-based targeted ad campaign, the ideal age distribution of audience members exposed to ads of the campaign may consist of one or two age-based demographic groups. The targeted score (Sₜ) is based on an impulse response of the age-correction model when audience members records associated with individual demographic groups are used to validate the age-correction model. The impulse response is the percentage of the audience member records in an age category for which the candidate model correctly predicts the age category. For example, for 1000 audience members records of the validation set having true ages between 25-34, the age-correction model may predict that 97 audience members records are in the 18-24 age category, 855 audience members records are in the 25-34 age category, 42 audience members records are in the 35-54 age category, and 6 audience members records are in the 55+ age category. In such an example, the impulse response is 0.86.

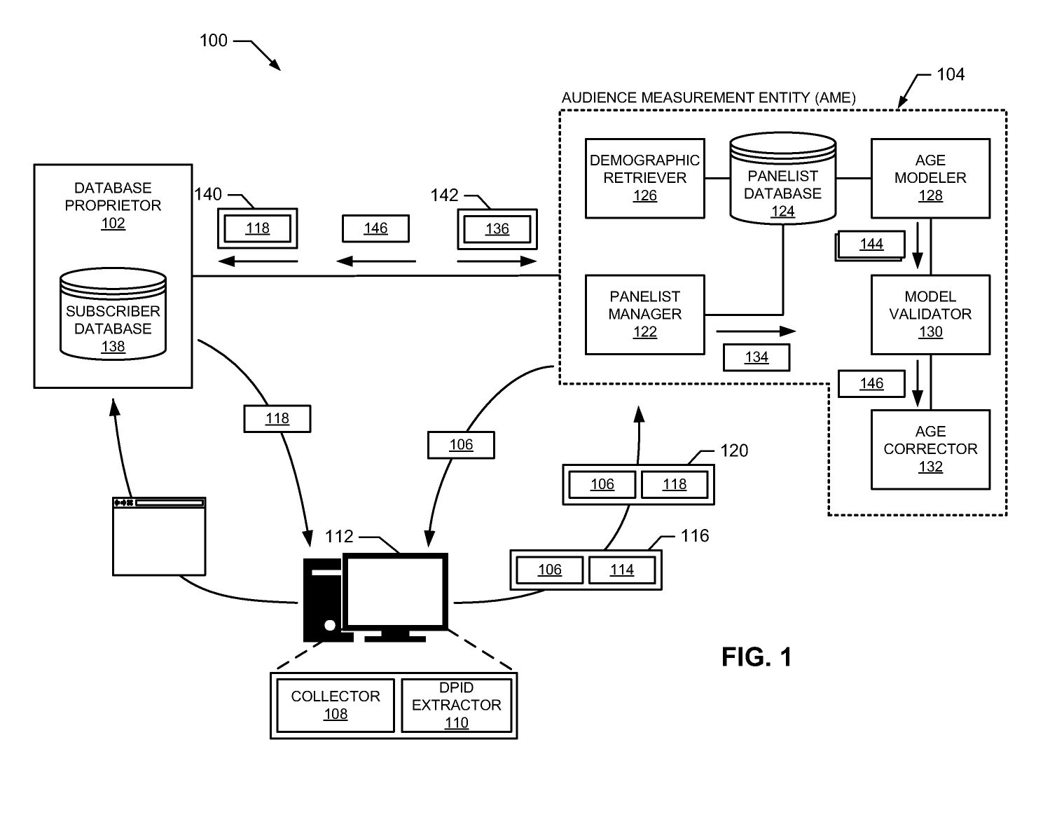

FIG. 1 illustrates an example system 100 to generate an age correction model used to be used to correct age information associated with demographic impressions logged by a database proprietor 102. In the illustrated example, an AME 104 provides an AME identifier (AME ID) 106, a collector 108, and a database proprietor identifier (DPID) extractor 110 to a computing device 112 (e.g., a desktop, a laptop, a tablet, a smartphone, etc.) associated with a panelist household. For example, the AME 104 may provide the collector 108, the DPID extractor 110, and the AME ID 106 via a registration website. In some examples, the collector 108 and the DPID extractor 110 are performed by instructions (e.g., Java, java script, or any other computer language or script) embedded in the registration website, or any other suitable website. In some examples, the AME ID 106 is a cookie or is encapsulated in a cookie set in the computing device 112 by the AME 104. Alternatively, the AME ID 106 could be any other user and/or device identifier (e.g., an email address, a user name, etc.). In any case, the example AME ID 106 is an alphanumeric value that the AME 104 uses to uniquely identify the panelist household associated with the computing device 112.

In the illustrated example, member(s) of the panelist household (e.g. a head of household) provide(s) detailed demographic information 114 (e.g., true age, ethnicity, first name, middle name, gender, household income, employment status, occupation, rental status, level of education, etc.) of the member(s) of the panelist household to the AME 104. In the illustrated example, the detailed demographic information 114 is provided via the computing device 112 through the registration website, or any other suitable website. The example computer device 112 sends an example registration message 116 that includes the AME ID 106 and the detailed demographic information 114. Alternatively, in some examples, AME 104 collects the detailed demographic information 114 though other suitable means, such as a telephone survey, a paper survey, or an in-person survey, etc.

In the illustrated example, when a member of the panelist household uses the computing device 112 to visit a website and/or use an app associated with a database proprietor 102, the database proprietor 102 sets or otherwise provides, on the computing device 112, a database proprietor identifier (DPID) 118 associated with subscriber credentials (e.g., user name and password, etc.) used to access the website and/or the app. In some examples, the DPID 118 is a cookie or is encapsulated in a cookie. Alternatively, the DPID 118 could be any other user and/or device identifier. The example DPID extractor 110 extracts the DPID 118 (e.g., from a cookie, etc.). The example collector 108 collects the DPIDs 118 on the computing device 112 and sends an example ID message 120 to the example AME 104. In the illustrated example, the ID message 120 includes the extracted DPID(s) 118 and the AME ID 106 corresponding to the panelist household. In some examples, the DPID extractor 110 remembers the DPIDs 118 that have been extracted and sends the ID message 120 when a new panelist DPID 118 has been extracted.

In the illustrated example, the AME 104 includes an example panelist manager 122, an example panelist database 124, an example demographic retriever 126, an example age modeler 128, an example model validator 130, and an example age corrector 132. The example panelist manager 122 receives the registration message 116 and the ID message(s) 120 from the computing device 112. Based on the registration message 116 and the ID message(s) 120, the panelist manager 122 generates a panelist household record 134 that associates the AME ID 106 to the detailed demographic information 114 and the DPID(s) 118 of the members of the panelist household. The example panelist manager 122 stores the example panelist household record 134 in the panelist database 124.

The example demographic retriever 126 is structured to retrieve database proprietor activity data 136 from the example database proprietor 102. In the illustrated example, the database proprietor 102 provides an application program interface (API) that provides access to a subscriber database 138 based on DPIDs (e.g., the DPIDs 118, etc.). The example subscriber database 138 includes the database proprietor activity data 136 of the subscribers to the database proprietor 102. The example demographic retriever 126 sends queries 140 to the database proprietor 102 that include the DPIDs 118 associated with the example panelist household records 134 in the example panelist database 124. In the illustrated example, in response to the queries 140, the database proprietor 102 sends query responses 142 to the AME 106. The example query responses 142 includes the database proprietor activity data 136 corresponding to the panelist DPID 118 of the example query 140. The example demographic retriever 126 stores the database proprietor activity data 136 in association with the corresponding panelist household record 134 in the panelist database 124.

The example age modeler 128 generates example candidate models 144 based on the panelist household records 134 in the example panelist database 124. To generate the candidate models 144, the age modeler 128 splits the panelist household records 132 into audience member records that each represent a member of one of the panelist households. For example, a panelist household may have three members (e.g., a father, a son, and a daughter, etc.). In such an example, the age modeler 128 creates three audience member records, with each of the audience member records including a portion of the detailed demographic data 114 and the database proprietor activity data 134 corresponding to the respective member of the panelist household.

The example age modeler 128 generates multiple training sets and multiple validation sets. For each one of the training sets and each one of the corresponding validation sets, the example age modeler 128 randomly or pseudo-randomly assigns the audience member records to either the training set or the validation set. For example, the audience member records may be split into a first training set and a first validation, and then the audience member records may be split into a second training set and a second validation set. In such an example, the composition of the audience member records in the first training set are different than composition of the audience member records in the second training set. In some examples, 80% of the audience member records are assigned to the training set, and the remaining 20% of the audience member records are assigned to the validation set. In the illustrated example, the example age modeler 128 generates the candidate models 144 using the training sets. In some examples, the age modeler 128 uses different modeling techniques (e.g., decision tree, regression, etc.) to generate the candidate models 144.

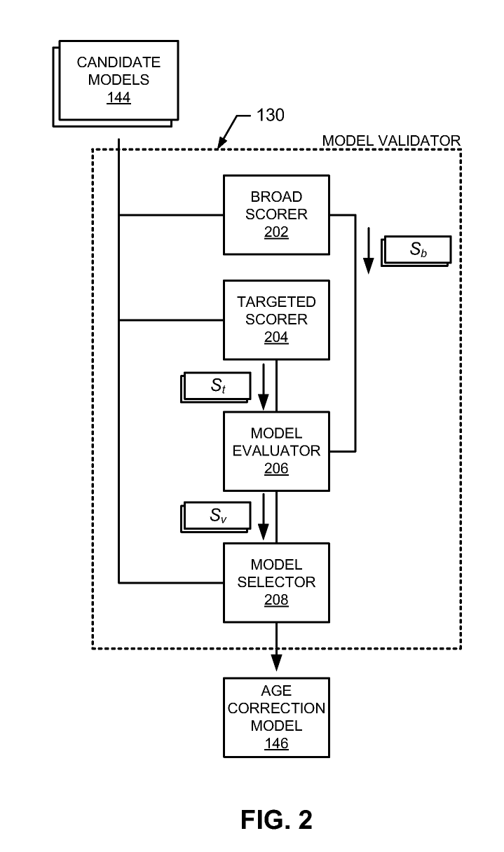

The example model validator 130 selects one of the candidate models 144 to be an age correction model 146 that is used by the age corrector 132 and/or the database proprietor 102 to correct the ages associated with media impressions. As described in more detail in connection with FIG. 2 below, the example model validator 130 calculates the validation scores (Sᵥ) for the candidate models 144 based on the validation sets generated by the example age modeler 128. The example model validator 130 selects the age correction model 146 based on the validation scores (Sᵥ). In some examples, the model validator 130 selects the candidate model 144 with the highest validation score (Sᵥ).

In some examples, when the AME 104 has access to database subscriber activity data 136 associated with individualized logged impressions, the age corrector 132 receives the age correction model 146 from the model validator 130. In some such examples, the example age corrector 132 uses the age correction model 146 to assign an age category, an age-based PDF and/or a discrete predicted age to the individualized logged media impression. For example, based on the subscriber activity data 136, the age correction model 146 may assigned an age of 23 to the individualized logged media impression.

Alternatively, in some examples, the AME 104 sends the age correction model 146 to the database proprietor 102. In some such examples, when the database proprietor 102 logs a media impression associated with a subscriber, the database proprietor 102 uses the age correction model 146 to assign the age category, the age-based PDF and/or the discrete age to the logged media impression. In some such examples, because the age based PDFs are fixed through the generation of the age correction model 146, the database proprietor 102 assigns a PDF identifier that identifies a particular age based PDF to the logged impression. In some such examples, the database proprietor 102 aggregates the logged impressions based on the PDF identifier. For example, the aggregate logged impression data from the database proprietor 102 may indicate that two thousand subscribers assigned to the “M7” age-based PDF were exposed to a “Waffle Barn” advertisement in the last seven days. In such an example, the “M7” age-based PDF may correspond to probability of the subscribers associated with the aggregate logged impression data being in the 18-21 age category is 3.2%, the probability of the subscribers being in the 22-27 age category is 86.9%, the probability of the subscribers being in the 28-33 age category is 9.4%, and the probability of the subscribers being in the 34-40 age category is 0.5%. In such an example, of the two thousand subscribers, the AME 104 would assign 64 subscribers to the 18-21 age category, 1738 subscribers to the 22-27 age category, 188 subscribers to the 28-33 age category, and 10 subscribers to the 34-40 age category.

FIG. 2 illustrates an implementation of the example model validator of 130 FIG. 1 to evaluate the candidate models 144 to select the age correction model 146. The example model validator 130 evaluates the candidate models 144 based on the validation sets. In some examples, the validation sets are retrieved and/or otherwise received from the age modeler 128 (FIG. 1). The example model validator 130 includes an example broad scorer 202, an example targeted scorer 204, an example model evaluator 206, and an example model selector 208.

The example broad scorer 202 calculates the broad scores (S_{b}) for the example candidate models 144 based on the validation sets. The broad scores (S_{b}) measure the reliability of the candidate models 144 when the media impressions from a media campaign encompass a variety of demographic groups (e.g., the possible audience as a whole, etc.). For example, an advertisement campaign may be designed and deployed so that audience members in the 13-17 age category, the 18-24 age category, the 25-34 age category, and the 35-54 age category are likely to be exposed to the advertisement.

To calculate the broad scores (S_{b}), the example broad scorer 202 applies one or more of the validations sets to the candidate models 144. Initially, the example broad scorer 202 calculates an error (e) for each of the demographic groups. The example broad scorer 202 calculates the error (e) based on equation 1 below

$${e}_{j} = \sqrt{\frac{{\sum }_{i = 1}^{{n}_{i}} {( {P}_{i , j} - {T}_{i , j}^{ } )}^{2}}{{\sum }_{i = 1}^{{n}_{i}} {T}_{i , j}^{2}}} \qquad Equation 1$$

In Equation 1 above, nᵢ is the number of validation sets applied to the candidate model 144 being scored, P_{i,j} is the predicted number of audience member records in the j^{th} demographic group of the i^{th} test set, and T_{i,j} is the actual number of audience member records in the j^{th} demographic group of the i^{th} test set. Table 1 below illustrates example predicted number of audience members (P), and example actual number of audience members (T) in a particular demographic group (j) for different test sets (i).

TABLE 2
EXAMPLE PREDICTED NUMBERS OF AUDIENCE
MEMBERS (P), AND EXAMPLE ACTUAL NUMBERS OF
AUDIENCE MEMBERS (T)
Demographic group (j): Ages 13-34

| Test Set (i) | Predicted (P) | Actual (T) | (P_{i,j} − T_{i,j})² | T²_{i,j} |
|---|---|---|---|---|
| 1 | 90 | 100 | 100 | 10000 |
| 2 | 81 | 95 | 196 | 9025 |
| 3 | 89 | 110 | 441 | 12100 |

In the example illustrated in Table 2 above, the error (e) for the 13-34 age category demographic group is 0.15 (sqrt((100+196+441)/(10000+9025+12100)).

The example broad scorer 202 calculates the broad scores (S_{b}) based on Equation 2 below.

$${S}_{b} = 1 - \frac{{\sum }_{j = 1}^{{n}_{g}} ( {e}_{j} {w}_{j} )}{{\sum }_{j = 1}^{{n}_{g}} ( {w}_{j} )} \qquad Equation 2$$

In Equation 2 above, n_{g} is a number of demographic groups, the error (eⱼ) is calculated based on Equation 1 above, wⱼ is the weight of the j^{th} demographic group. The weight (w) for each demographic group in the illustrated example is defined as the number of audience members in that demographic group in the validation set. For example, if there are 342 audience member records in the 13-17 age category demographic group, the weight (w) for the 13-17 age category demographic group is 342. Table 2 below illustrates example demographic groups, example errors (e), and example weights (w).

TABLE 2
EXAMPLE DEMOGRAPHIC GROUPS, EXAMPLE ERRORS
(e), AND EXAMPLE WEIGHTS (w)

| Demographic group | Error (e) | Weight (w) |
|---|---|---|
| Ages 13-34 | 0.15 | 200 |
| Ages 35-54 | 0.12 | 150 |
| Ages 55+ | 0.02 | 75 |

In the example illustrated in Table 1 above, the broad score (S_{b}) is 0.88 (1-(49.5/425).

The example targeted scorer 204 calculates the targeted scores (Sₜ) for the example candidate models 144 based on the validation sets. The targeted scores (Sₜ) measure the reliability of the candidate models 144 when the media impressions from a media campaign encompass a narrow set of demographic groups (e.g., one or two demographic groups, etc.). For example, an advertisement campaign may be designed and deployed so that audience members in the 13-17 age category are likely to be exposed to the advertisement.

To calculate the targeted scores (Sₜ), the example targeted scorer 204 divides each of the validation sets into subsets that include a single demographic group. For example, the validation set may have a first subset of the audience member records in the 13-34 age category demographic group, a second subset in the 35-54 age category demographic group, and a third subset in the 55+ age category demographic group. The subsets are applied to the candidate models 144, and the predictions for each subset form an impulse response matrix M. An example impulse response matrix M is illustrated in Table 3 below.

TABLE 3
EXAMPLE IMPULSE RESPONSE MATRIX (M)

| | | True Demographic Group | | |
|---|---|---|---|---|
| | | Ages 13-34 | Ages 35-54 | Ages 55+ |
| Predicted | Ages 13-34 | 0.85 | 0.10 | 0.01 |
| Demographic | Ages 35-54 | 0.12 | 0.88 | 0.01 |
| Group | Ages 55+ | 0.03 | 0.02 | 0.98 |

The example impulse response matrix (M) represented in Table 3 above, 85% of the audience member records in the 13-34 age category demographic group were predicted to be in the 13-34 age category demographic group, 12% of the audience member records in the 13-34 age category demographic group were predicted to be in the 35-54 age category demographic group, and 3% of the audience member record in the 13-34 age category demographic group were predicted to be in the 55+ age category demographic group. As a result, in the example of Table 3 above, for the 13-34 age category demographic group, the particular candidate model 144 misattributed 15% of the audience member records in the 13-34 age category demographic group of the validation set. In the example, the misattribution includes the 12% of the audience member records in the 13-34 age category demographic group that were predicted to be in the 35-54 age category demographic group and the 3% of the audience member records in the 13-34 age category demographic group that were predicted to be ages 55++(e.g., demographic groups other than the actual demographic group).

Based on the impulse response matrix (M), the target scorer 204 calculates the targeted score (Sₜ) based on Equation 3 below.

$${S}_{t} = \frac{{\sum }_{j = 1}^{{n}_{g}} ( {M}_{j , j} ⋆ {w}_{j} )}{{\sum }_{j = 1}^{{n}_{g}} ( {w}_{j} )} \qquad Equation 3$$

In Equation 3 above, n_{g} is a number of demographic groups, M_{j,j} is a value in the j^{th} row and the j^{th} column of the impulse response matrix (M), and wⱼ is the weight of the j^{th} demographic group. In the illustrated example, the weight (w) for each demographic group is defined as the number of audience member records in that demographic group in the validation set. For example, if the number of audience member records in the 35-54 age category demographic group is 200, the number of audience member records in the 35-54 age category demographic group is 150, and the number of audience member records in the 55+ age demographic group is 75, the targeted score (Sₜ) of the example corrective model represented by the example impulse response matrix M illustrated on Table 3 above is 0.88 (e.g., 0.88=Sₜ=(0.85*200+0.88*150+0.98*75)/(200+150+75)).

In the illustrated example, the model evaluator 206 retrieves and/or otherwise receives the broad scores (S_{b}) for the candidate models 144 from the broad scorer 202 and the targeted scores (Sₜ) for the candidate models 144 from the target scorer 204. The example model evaluator 206 calculates the validation scores (Sᵥ) for the candidate models 144 based on the corresponding broad scores (S_{b}) and the corresponding targeted scores (Sₜ). In some examples, the model evaluator 206 calculates a weighted average of the broad score (S_{b}) and the targeted scores (Sₜ) with a broad weight (W_{b}) and a targeted weight (Wₜ) respectively. In some such examples, the validation score (Sᵥ) is calculated based on with Equation 4 below.

$${S}_{v} = \frac{{S}_{b} {W}_{b} + {S}_{t} {W}_{t}}{{W}_{b} + {W}_{t}} \qquad Equation 4$$

In some examples, the broad weight (W_{b}) is a quantity of broad campaigns that were executed over a time period (e.g., one year, five years, etc.) and the target weight (Wₜ) is a quantity of narrow campaigns that were executed over the same time period. For example, for one of the candidate models 144, if the broad weight (W_{b}) is 256 and the target weight (Wₜ) is 649, the broad score (S_{b}) is 0.92 and the targeted score (Sₜ) is 0.62, the validation score (Sᵥ) is 0.70 ((0.92*256+0.62*649)/(256+649)).

The example model selector 208 selects one of the candidate models 144 to be the age correction model 146 based on the validation scores (Sᵥ) calculated by the example model evaluator 206. In some examples, the model selector 208 selects the candidate model 144 that is associated with the highest validation score (Sᵥ). Example validation scores (Sᵥ) for the example candidate models 144 are shown on Table 4 below.

TABLE 4
EXAMPLE VALIDATION SCORES (Sᵥ) FOR THE EXAMPLE
CANDIDATE AGE CORRECTION MODELS

| Candidate Model | S_{b} | Sₜ | Sᵥ |
|---|---|---|---|
| First Candidate Model | 0.63 | 0.85 | 0.76 |
| Second Candidate Model | 0.77 | 0.75 | 0.76 |
| Third Candidate Model | 0.74 | 0.68 | 0.71 |
| Fourth Candidate Model | 0.98 | 0.64 | 0.78 |

On Table 4 above, the broad weight (W_{b}) is 505 and the targeted weight (Wₜ) is 706. In the example shown on Table 4 above, the model selector 208 may selected the fourth candidate model because the fourth candidate model is associated with the highest validation score (Sᵥ). Alternatively or additionally, in some examples, the model selector 208 selects one of the candidate models 144 that satisfies (e.g., is greater than) a threshold validation score. In some such examples, if none of the candidate models 144 satisfy the threshold validation score, the model selector 208 does not select any of the candidate models 144. In the example shown on Table 4 above, if the threshold validation score is 0.80, the model selector 208 does not select any of the candidate models 144. In some such examples, the model selector 208 instructs the age modeler 128 (FIG. 1) to regenerate the candidate models 144.

While an example manner of implementing the model validator 130 of FIG. 1 is illustrated in FIG. 2, one or more of the elements, processes and/or devices illustrated in FIG. 2 may be combined, divided, re-arranged, omitted, eliminated and/or implemented in any other way. Further, the example broad scorer 202, the example targeted scorer 204, the example model evaluator 206, the example model selector 208 and/or, more generally, the example model validator 130 of FIG. 1 may be implemented by hardware, software, firmware and/or any combination of hardware, software and/or firmware. Thus, for example, any of the example broad scorer 202, the example targeted scorer 204, the example model evaluator 206, the example model selector 208 and/or, more generally, the example model validator 130 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one the example broad scorer 202, the example targeted scorer 204, the example model evaluator 206, and/or the example model selector 208 is/are hereby expressly defined to include a tangible computer readable storage device or storage disk such as a memory, a digital versatile disk (DVD), a compact disk (CD), a Blu-ray disk, etc. storing the software and/or firmware. Further still, the example model validator 130 of FIG. 1 may include one or more elements, processes and/or devices in addition to, or instead of, those illustrated in FIG. 2, and/or may include more than one of any or all of the illustrated elements, processes and devices.

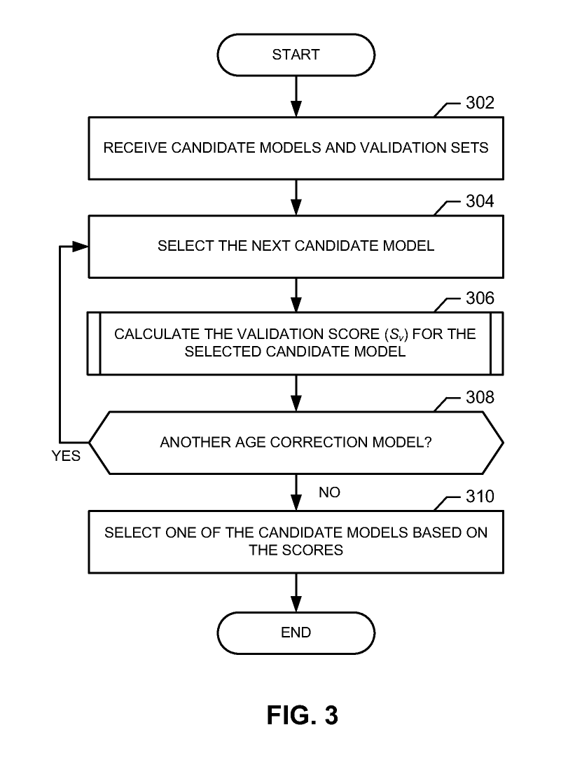

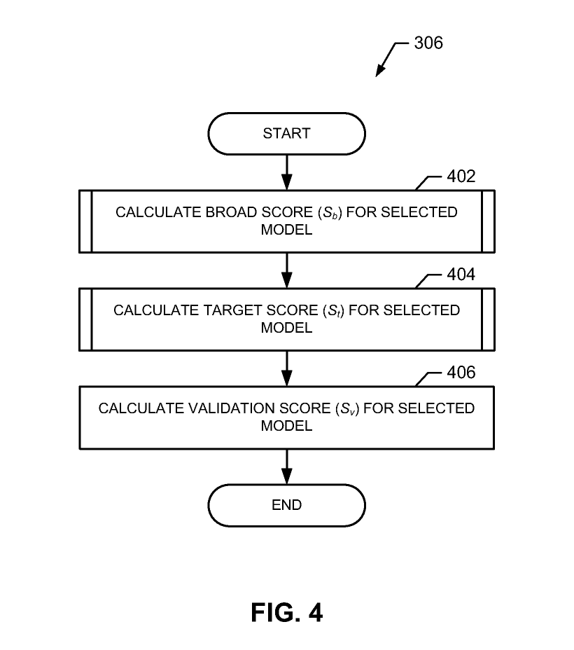

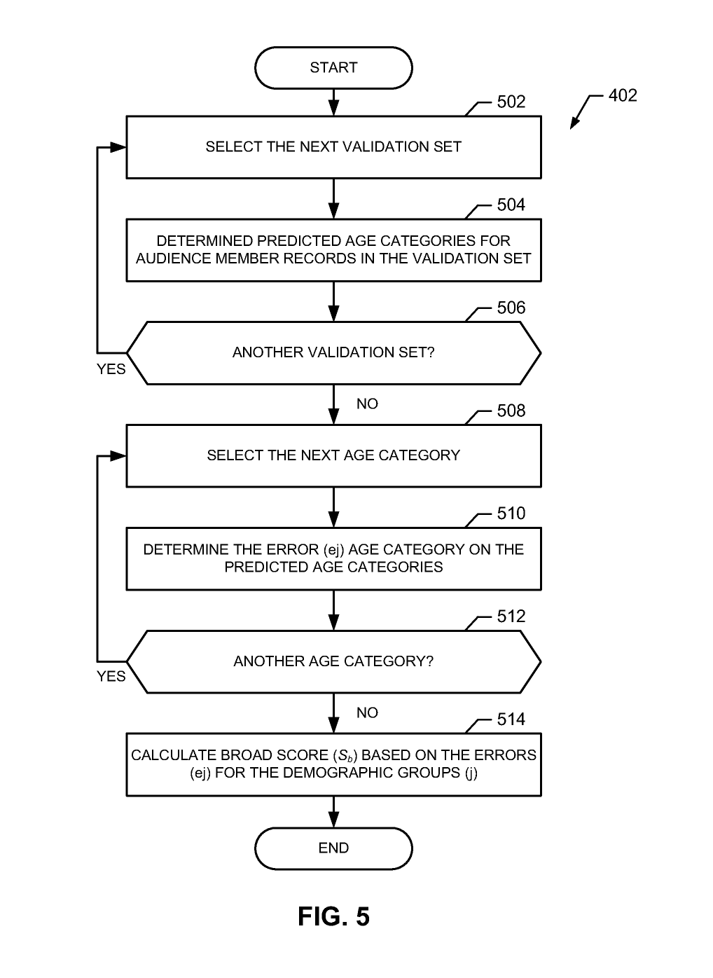

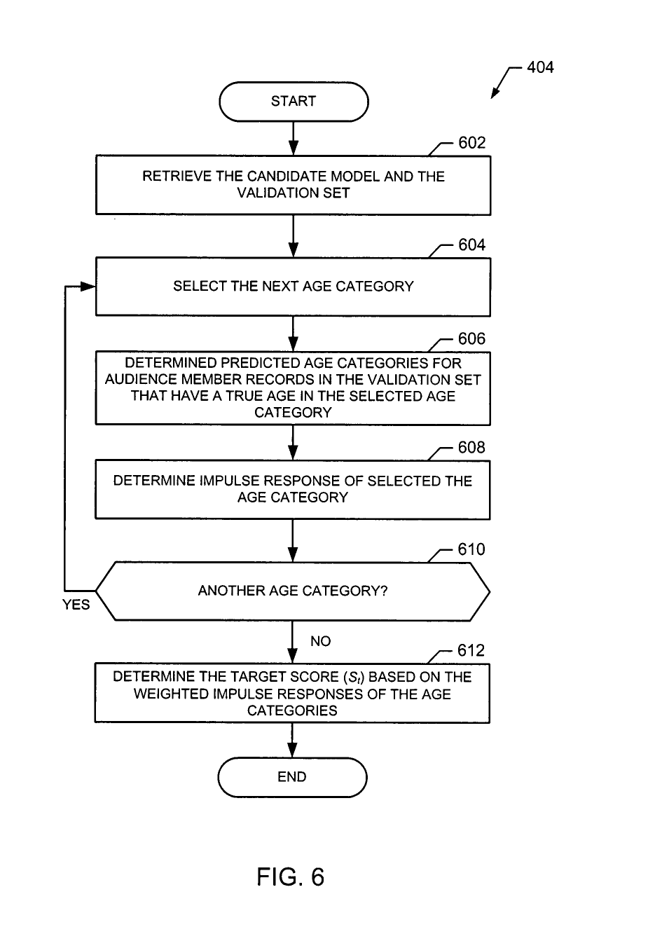

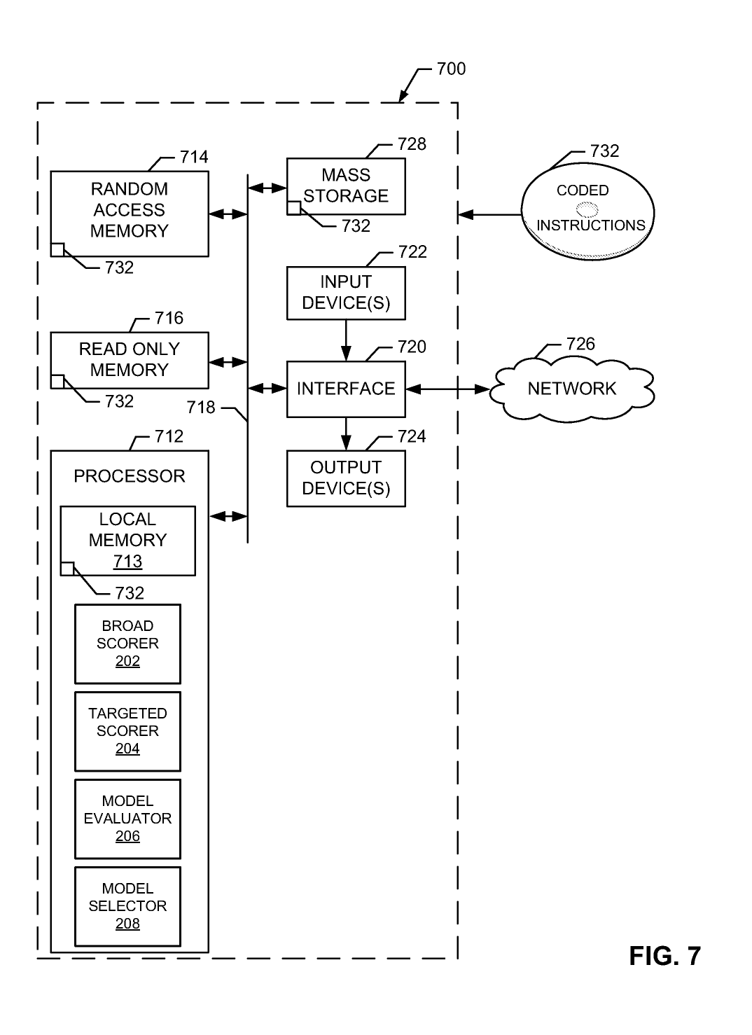

Flowcharts representative of example machine readable instructions for implementing the example model validator 130 of FIGS. 1 and/or 2 are shown in FIGS. 3 and/or 4. A flowchart representative of example machine readable instructions for implementing the example broad scorer 202 of FIG. 2 is shown in FIG. 5. A flowchart representative of example machine readable instructions for implementing the example targeted scorer 204 of FIG. 2 is shown in FIG. 6. In this example, the machine readable instructions comprise program(s) for execution by a processor such as the processor 712 shown in the example processor platform 700 discussed below in connection with FIG. 7. The program(s) may be embodied in software stored on a tangible computer readable storage medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 3, 4 5, and/or 6, many other methods of implementing the example model validator 130 may alternatively be used. For example, the order of execution of the blocks may be changed, and/or some of the blocks described may be changed, eliminated, or combined.

As mentioned above, the example processes of FIGS. 3, 4 5, and 6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 3, 4 5, and 6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 3 is a flow diagram of example machine readable instructions that may be executed to implement the example model validator 130 of FIGS. 1 and/or 2 to evaluate the candidate models 144 (FIGS. 1 and 2) and select the age correction model 146 (FIGS. 1 and 2). Initially, the example model validator 130 receives the example candidate models 144 and the validation sets from the age modeler 128 (FIG. 1) (block 302). The example model validator 130 selects the next candidate model 144 (block 304). The example model validator 130 calculates the validation score (Sᵥ) for the candidate model 144 selected at block 304 (block 306). An example to calculate the validation score (Sᵥ) for the selected candidate model 144 is discussed below in connection with FIG. 4. The example model validator 130 determines whether there is another candidate model 144 to score (block 308). If there is another candidate model 144 to score, the example model validator 130 selects the next candidate model 144 (block 304). Otherwise, if there is not another candidate model to score, the example model validator 130 selects one of the candidate models 144 to be the age correction model 146 based on the validation scores (Sᵥ) calculated at block 306 (block 310). The example program of FIG. 3 then ends.

FIG. 4 is a flow diagram of example machine readable instructions that may be executed to implement the example model validator 130 of FIGS. 1 and/or 2 to evaluate the candidate models 144 (FIGS. 1 and 2). Initially, the example broad scorer 202 (FIG. 2) calculates the broad scored (S_{b}) for the candidate model 144 being evaluated (block 402). An example for calculating the broad scored (S_{b}) is described in connection with FIG. 5 below. The example targeted scorer 204 (FIG. 2) calculates the targeted score (Sₜ) for the candidate model 144 being evaluated (block 404). An example for calculating the targeted score (Sₜ) is described in connection with FIG. 6 below. The example model evaluator 206 (FIG. 2) calculates the validation score (Sᵥ) based on the broad scored (S_{b}) and the targeted score (Sₜ) (block 406). In some examples, the example model evaluator 206 based on Equation 4 above. The example program of FIG. 4 then ends.

FIG. 5 is a flow diagram of example machine readable instructions that may be executed to implement the example broad scorer 202 of FIG. 2 to calculate the broad scores (S_{b}) for the candidate models 144 (FIGS. 1 and 2). Initially, the broad scorer 202 selects the next validation set (e.g., received from the age modeler 128 of FIG. 1) (block 502). The broad scorer 202 applies to the validation set to candidate model 144 (FIGS. 1 and 2) to determine predicted age categories for the audience member records in the validation set (block 504). For example, for 250 audience member records in validation model, the candidate model 144 may assign 118 audience member records to the 13-18 age category, 79 audience member records to the 19-34 age category, 29 audience member records to the 35-54 age category, and 24 audience member records to the 55+ age category. The broad scorer 202 determines if there is another validation set (block 506). If there is another validation set, the broad scorer selects the next validation set (block 502).

Otherwise, the broad scorer 202 selects an age category (j) (block 508). For example, the broad scorer 202 may select the 13-17 age category. The example broad scorer 202 determines the error (eⱼ) for the age category predicted selected at block 508 based on the predicted age categories for the audience member records of the validation sets (block 510). In some examples, the broad scorer 202 determines the error (eⱼ) for the age category according to Equation 1 above. The example broad scorer 202, determines if there is another age category for which to determine the error (block 512). If there is, the example broad scorer 202 selects the next age category (block 508). Otherwise, the broad scorer 202 calculates the broad score (S_{b}) based on the errors (eⱼ) calculated at block 510 (block 514). In some examples, the broad scorer 202 calculates the broad score (S_{b}) based on Equation 2 above. The example program of FIG. 5 then ends.

FIG. 6 is a flow diagram of example machine readable instructions that may be executed to implement the example targeted scorer 204 of FIG. 2 to calculate targeted scores for the candidate models 144 (FIGS. 1 and 2). Initially, the example targeted scorer 204 retrieves and/or otherwise receives the candidate model 144 and the validation set (e.g., from the age modeler 128 of FIG. 1) (block 602). The example targeted scorer 204 selects the next age category to analyze (block 604). For example, the targeted scorer 204 may select the 19-34 age category.

The example targeted scorer 204 executes the candidate model 144 retrieved at block 602 to determine the predicted age categories for the audience member records in the validation set that have a true age in the age category selected at block 604 (block 606). For example, for 105 audience member records in the validation set with the true age in the 19-34 age category, the candidate model 144 may predict that 13 of the audience member records are in the 13-18 age category, 79 of the audience member records are in the 19-34 age category, and 13 of the audience member records are in the 35-54 age category. The example targeted scorer 204 determines the impulse response of the age category selected act block 604 (block 608). In the example above, the impulse response of the 19-34 age category is 0.75. In some examples, targeted scorer 204 applies the weight (w) to the impulse response. In some such examples, the weight is equal to the quantity of audience member records in the validation set with the true age in the selected age category. In the example above, the weight (w) may be 105 and the weighted impulse response for the 19-34 age category may be 78.75. In some example, the weight is also affected by other demographic measures, such as percentage of the population in that age category. For example, the weight (w) for the 19-34 age category may be 105×0.21, and the weighted impulse response for the 19-34 age category may be 16.54.

The example target scorer 204 determines whether there is another age category for which to calculate another impulse response (block 610). If there is another age category, the example target scorer 204 selects the next age category (block 604). Otherwise, the target scorer 204 determines the target score (Sₜ) based on the weighted impulse responses of the age categories (block 612). The example program of FIG. 6 then ends.

FIG. 7 is a block diagram of an example processor platform 1000 capable of executing the instructions of FIGS. 3, 4, 5, and 6 to implement the model validator 130 of FIGS. 1 and 2. The processor platform 1000 can be, for example, a server, a personal computer, a workstation, or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer. In the illustrated example, the processor 712 is structured to include the example broad scorer 202, the example targeted scorer 204, the example model evaluator 206, and the example model selected 208.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives.

Coded instructions 732 of FIGS. 3, 4, 5, and/or 6 may be stored in the mass storage device 728, in the volatile memory 714, in the non-volatile memory 716, and/or on a removable tangible computer readable storage medium such as a CD or DVD.

From the foregoing, it will appreciate that examples disclosed herein allow objective evaluation of age correction models before the age correction models is/are deployed. As such, the examples disclosed herein reduce processor resources use (e.g. processor cycles, etc.) by reducing and/or eliminating the verification of the model after live audience member records are processed. That is, the results of the age correction model on the live audience member records do not need to be revalidated.

Furthermore, examples disclosed herein solve a problem specifically arising in the realm of computer networks in the Internet age. Namely, as a large variety of media is increasingly accessed via the Internet by more people, the AME cannot rely on traditional techniques (e.g., telephone surveys, panelist logbooks, etc.) to measure audiences of the variety of the media. Additionally, because the database proprietor data used to measure the audiences is self-reported, the database proprietor data may include inaccuracies that cannot be corrected or verified by the AME through the traditional techniques. For example, because the audience member interacts with the database proprietor in a first Internet domain, the AME in a second Internet domain, and the media in a third Internet domain, the AME cannot verify the demographic information (e.g., true age, etc.) of the audience member using the traditional techniques (e.g., a survey, etc.). Examples disclosed herein solve this problem by using demographic information and activity data of known audience members (e.g., the panelists) that interact with the database proprietor in the first Internet domain and the AME in the second Internet domain to correct the demographic information of unknown audience members (e.g., audience members that interact with the database proprietor in the first Internet domain without interacting with the AME in the second Internet domain).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to correct age misattribution in a media impression, the method comprising:
for a plurality of candidate models:
determining, with a processor, a first score for the candidate model based on audience member records stored in a first memory;
determining, with the processor, a second score for the candidate model based on the audience member records stored in the first memory; and
determining, with the processor, a third score based on a weighted average of the first score and the second score, the third score representative of the accuracy of the corrective model;
selecting, with the processor, one of the plurality of candidate models to be an age-correction model based on the third score; and
correcting, based on the selected age-correction model, an age associated with the media impression stored in a second memory, the media impression indicative of a person being exposed to media presented by a media presentation device.

2. The method as defined in claim 1, wherein the determining of the second score further includes:
determining an impulse response of the candidate model for a plurality of age categories based on a validation set of audience member records;
assigning a weight to the impulse responses; and
calculating an average of the weighted impulse responses.

3. The method as defined in claim 2, wherein the impulse responses are weighted based on respective quantities of the audience member records within the corresponding age category.

4. The method as defined in claim 1, wherein the determining of the first score further includes:
executing the candidate model to predict age categories for a plurality of validation sets;
for the age categories:
determining a plurality of errors based on the predicted age categories; and
determining an age category error based on a weighted average of the plurality of errors.

5. The method as defined in claim 4, further including determining the first score based on a weighted average of the age category errors corresponding to the plurality of age categories.

6. The method as defined in claim 1, wherein the selecting of the one of the plurality of candidate models further includes selecting the one of the plurality of candidate models associated with the highest third score.

7. The method as defined in claim 1, wherein the selecting of the one of the plurality of candidate models further includes selecting the one of the plurality of candidate models that (i) satisfies a validation threshold and (ii) is associated with the highest third score.

8. An apparatus to correct age misattribution in a media impression, the apparatus comprising:
a model validator to:
for a plurality of candidate models:
determine a first score for the candidate model based on audience member records stored in a first memory;
determine a second score for the candidate model based on the audience member records stored in the first memory; and
determine a third score based on a weighted average of the first score and the second score, the third score representative of the accuracy of the corrective model; and
select one of the plurality of candidate models to be an age-correction model based on the third score; and
an age corrector to correct, based on the selected age-correction model, an age associated with the media impression stored in a second memory, the media impression indicative of a person being exposed to media presented by a media presentation device.

9. The apparatus as defined in claim 8, wherein the model validator includes a second scorer to:
determine an impulse response of the candidate model for a plurality of age categories based on a validation set of audience member records;
assign a weight to the impulse responses; and
determine the second score based on an average of the weighted impulse responses.

10. The apparatus as defined in claim 9, wherein the impulse responses are weighted based on respective quantities of the audience member records within the corresponding age category.

11. The apparatus as defined in claim 9, wherein the model validator includes a first scorer to:
execute the candidate model to predict age categories for a plurality of validation sets;
for the age categories:
determine a plurality of errors based on the predicted age categories; and
determine an age category error based on a weighted average of the plurality of errors.

12. The apparatus as defined in claim 11, wherein the first scorer is further to determine the first score based on a weighted average of the age category errors corresponding to the plurality of age categories.

13. The apparatus as defined in claim 8, wherein to select one of the plurality of candidate models, the model validator is to select the one of the plurality of candidate models associated with the highest third score.

14. The apparatus as defined in claim 8, wherein to select one of the plurality of candidate models, the model validator is to select the one of the plurality of candidate models that (i) satisfies a validation threshold and (ii) is associated with the highest third score.

15. A tangible computer readable storage medium comprising machine readable instructions that, when executed, cause a machine to at least:
for a plurality of candidate models:
determine a first score for the candidate model based on audience member records stored in a first memory;
determine a second score for the candidate model based on the audience member records stored in the first memory; and
determine a third score based on a weighted average of the first score and the second score, the third score representative of the accuracy of the corrective model;
select one of the plurality of candidate models to be an age-correction model based on the third score; and
correct, based on the selected age-correction model, an age associated with the media impression stored in a second memory, the media impression indicative of a person being exposed to media presented by a media presentation device.

16. The tangible computer readable storage medium as defined in claim 15, wherein to determine the second score, the instructions cause the machine to:
determine an impulse response of the candidate model for a plurality of age categories based on a validation set of audience member records;
assign a weight to the impulse responses; and
calculate an average of the weighted impulse responses.

17. The tangible computer readable storage medium as defined in claim 16, wherein the impulse responses are weighted based on respective quantities of the audience member records within the corresponding age category.

18. The tangible computer readable storage medium as defined in claim 15, wherein to determine the first score, the instructions cause the machine to:
execute the candidate model to predict age categories for a plurality of validation sets;
for the age categories:
determine a plurality of errors based on the predicted age categories; and
determine an age category error based on a weighted average of the plurality of errors.

19. The tangible computer readable storage medium as defined in claim 18, wherein the instructions cause the machine to determine the first score based on a weighted average of the age category errors corresponding to the plurality of age categories.

20. The tangible computer readable storage medium as defined in claim 15, wherein to select of the one of the plurality of candidate models, the instructions cause the machine to select the one of the plurality of candidate models associated with the highest third score.
